(19) United States
(12) Patent Application Publication
(10) Pub. No.: US 2025/0242700 A1
(43) Pub. Date: Jul. 31, 2025

(54) WIND-SOLAR HYBRID POWER GENERATION APPARATUS AND ELECTRICITY-POWERED VEHICLE

(71) Applicant: EISHINTRUST CO., LTD., Ushiku-shi (JP)

(72) Inventor: Tokuo Hashimoto, Ushiku-shi (JP)

(73) Assignee: EISHINTRUST CO., LTD., Ushiku-shi (JP)

(21) Appl. No.: 19/071,396

(22) Filed: Mar. 5, 2025

Related U.S. Application Data
(63) Continuation of application No. PCT/JP2023/031351, filed on Aug. 29, 2023.

(30) Foreign Application Priority Data
Sep. 7, 2022 (JP) 2022-142596

(51) Int. Cl. B60L 8/00; B63H 21/17; H02S 20/30

(52) U.S. Cl. CPC B60L 8/003; B60L 8/006; B63H 21/17; H02S 20/30; B63H 2021/171

(57) ABSTRACT

A wind-solar hybrid power generation apparatus includes a square-shaped casing that opens at a front and a rear, a power generation motor that is installed inside the casing, and a solar power generation panel that is placed on an upper surface of the casing. The power generation motor includes a main body that is fixed to a bottom surface of the casing or at a position where the casing is installed, a rotation shaft that is rotatably provided in the main body, a coupling rod that is connected to the rotation shaft and bent downward in a hook shape, and a blade that is continuously provided to the coupling rod. The wind-solar hybrid power generation apparatus has a low height by rotating the blade horizontally with respect to a surface of the position where the casing is installed.

### TECHNICAL FIELD

The invention of the present application relates to a wind-solar hybrid power generation apparatus that unitizes wind and solar power generation, improves ease of attachment and detachment, reduces air resistance due to its low height without sacrificing appearance, reduces objects falling off and vehicle rollover caused by crosswinds, and has an increased installation environment. The invention of the present application also relates to an electricity-powered vehicle equipped with the same.

### BACKGROUND ART

Patent Literature 1 describes an electric vehicle including a wind power generation unit as a vehicle equipped with a wind-solar hybrid power generation apparatus using wind and solar power.

The invention of Patent Literature 1 relates to an electric vehicle equipped with a wind power generation unit that provides assistance by generating electricity through wind power, which is a different type of renewable energy other than sunlight, and includes one or more wind power generation units at predetermined locations of the electric vehicle, the one or more wind power generation units including a solar power generation module that is fitted with a storage battery and is driven by a motor. The wind power generation unit is a cylindrical body that has a cavity, is provided with one or more wind turbines in the cavity, generates electricity by using a generator coupled to the wind turbine and by also being provided with a vibration power generation apparatus, and assists charging by being connected to the storage battery via a connector.

However, in conventional power generation apparatuses including wind power and solar power generation panels, such as in Patent Literature 1, the solar power generation panels are separate from the wind power, which complicates attaching, detaching, and fixing installation work. Since blades of a wind power generation apparatus rotate orthogonally with respect to wind flow, the wind power generation apparatus needs to be tall. As a result, the appearance of the electric vehicle is not only sacrificed, but traveling resistance is caused and fuel efficiency is reduced. Furthermore, weight balance is deteriorated and a risk of vehicle rollover due to being affected by crosswinds is increased.

### CITATION LIST

### Patent Literature

### Patent Literature 1

Japanese Utility Model Registration No. 3169807

### SUMMARY OF INVENTION

### Technical Problem

The present invention has an object to provide a wind-solar hybrid power generation apparatus that unitizes wind and solar power generation, improves ease of attachment and detachment, reduces air resistance due to its low height without sacrificing appearance, reduces objects falling off and vehicle rollover caused by crosswinds, and has an increased installation environment. The present invention also has an object to provide an electricity-powered vehicle equipped with the same.

### Solution to Problem

In order to solve the above-described problems, the present invention has the following configurations.

(1)

A wind-solar hybrid power generation apparatus including:

a square-shaped casing that opens at a front and a rear;

a power generation motor that is installed inside the casing; and

a solar power generation panel that is placed on an upper surface of the casing, wherein

the power generation motor includes:

a main body that is fixed to a bottom surface of the casing or at a position where the casing is installed;

a rotation shaft that is rotatably provided in the main body;

a coupling rod that is connected to the rotation shaft and bent downward in a hook shape; and

a blade that is continuously provided to the coupling rod, and

the blade rotates horizontally with respect to a surface of the position where the casing is installed.

(2)

The wind-solar hybrid power generation apparatus according to (1), including four pairs of the coupling rod and the blade.

(3)

The wind-solar hybrid power generation apparatus according to (1), wherein a front surface of the casing in a wind flow direction increases rotation efficiency of the blade by covering a half of the front surface with a plate and not allowing wind to pass through. (4)

The wind-solar hybrid power generation apparatus according to (3), wherein a mesh is installed on the front surface of the casing in the wind flow direction to prevent flying objects from hitting the power generation motor.

(5)

The wind-solar hybrid power generation apparatus according to (1), the blade includes a closing portion that has a convex shape curved toward a rotation direction and does not allow wind to escape from an end portion when being perpendicular to wind flow.

(6)

The wind-solar hybrid power generation apparatus according to (1), wherein the power generation motor is installed in plurality in a vertical line in a wind flow direction.

(7)

The wind-solar hybrid power generation apparatus according to (1), wherein a rear opening of the casing in a wind flow direction is larger than a front opening, which creates negative air pressure at the rear, accelerates wind flow, and efficiently causes the power generation motor to rotate.

(8)

The wind-solar hybrid power generation apparatus according to (4), wherein a side at which the mesh of the plate is installed is installed so as to be located and incline toward a rear in the wind flow direction, increasing an amount of wind flow from the mesh.

(9)

An electricity-powered vehicle comprising the wind-solar hybrid power generation apparatus according to any one of (1) to (8) on an upper surface of an electric vehicle.

(10)

The electricity-powered vehicle according to (9), wherein a connection between the wind-solar hybrid power generation apparatus and the electric vehicle is of an attachment/detachment type or a fixed type.

(11)

A building comprising the wind-solar hybrid power generation apparatus according to any one of (1) to (8).

(12)

A train comprising the wind-solar hybrid power generation apparatus according to any one of (1) to (8).

(13)

A ship comprising the wind-solar hybrid power generation apparatus according to any one of (1) to (8).

### ADVANTAGEOUS EFFECTS OF INVENTION

The invention of the present application can provide a wind-solar hybrid power generation apparatus that improves ease of attachment and detachment, reduces air resistance due to its low height while realizing a shape that does not sacrifice appearance, reduces objects falling off from an installation place due to crosswinds, reduces vehicle rollover in the case of an electric vehicle, and has an increased installation environment, since the above-described configurations unitize wind and solar power generation. The invention of the present application can also provide an electricity-powered vehicle equipped with the same. Furthermore, the wind-solar hybrid power generation apparatus according to the present invention can be used on a train and a ship to generate power by being attached to a portion that receives sunlight and receives wind.

### BRIEF DESCRIPTION OF DRAWINGS

FIG. 1 is a partially transparent schematic diagram of a front of an electricity-powered vehicle (upstream (front) with respect to wind flow) according to the present invention.

FIG. 2 is a partially transparent schematic diagram of a front view of a first embodiment of the wind-solar hybrid power generation apparatus according to the present invention.

FIG. 3 is a partially transparent schematic diagram of a plan view of the first embodiment of the wind-solar hybrid power generation apparatus according to the present invention.

FIG. 4 is a horizontal cross-sectional schematic diagram of a blade.

FIG. 5 is a partially transparent schematic diagram of a plan view of a second embodiment of the wind-solar hybrid power generation apparatus according to the present invention.

### Description of Embodiments

Hereinafter, the invention of the present application will be described in detail with reference to the drawings. Note that the present invention is not limited to the following embodiments.

### Embodiment 1

An electricity-powered vehicle 1 according to the present invention includes a conventional electric vehicle 2 and a wind-solar hybrid power generation apparatus 11 installed on an upper surface of the electric vehicle 2, the upper surface here being an upper surface of a boarding section. An upper surface of a hood or a trunk can also be employed as the upper surface of the electric vehicle 2.

An attachment/detachment method using a jig (for example, a ski carrier type) that is detachable and does not fall off or break when the vehicle is traveling, or a fixing method for integrally fixing the wind-solar hybrid power generation apparatus 11 by being welded or the like to the electric vehicle can be employed as a method for installing the wind-solar hybrid power generation apparatus 11 on the electric vehicle 2 of the electricity-powered vehicle 1. It is easy to use the attachment/detachment method for retrofitting existing electric vehicles. Generated electricity is supplied to the storage battery in a self-propelled vehicle, a self-propelled vehicle motor, and the like similar to the related art (illustration omitted).

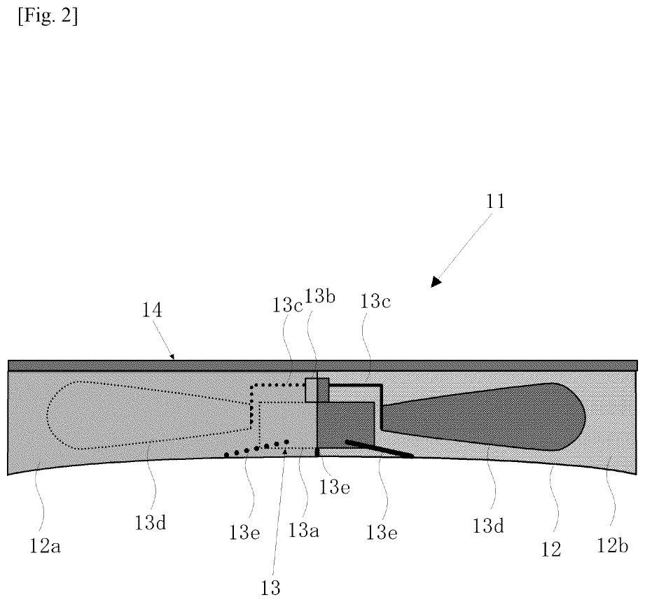

The wind-solar hybrid power generation apparatus 11 includes a casing 12, a power generation motor 13 installed inside the casing 12, and a solar power generation panel 14 placed on an upper surface of the casing 12, as shown in detail in FIGS. 2 to 4. Electricity generated through wind power and the solar power generation panel 14 is connected to an existing circuit of the electric vehicle 2, and may be used to drive the vehicle as is or may be stored to be used afterward.

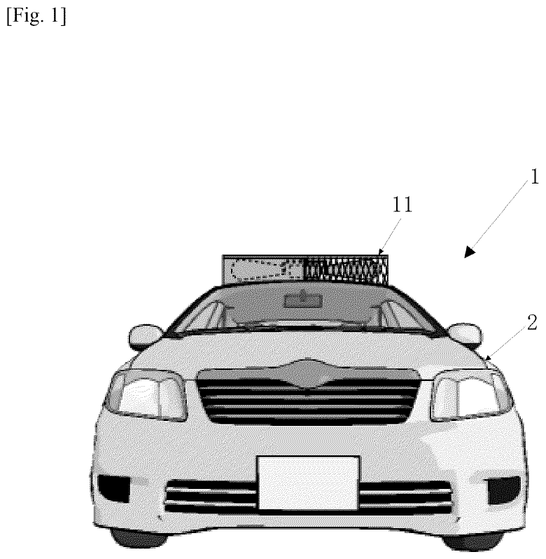

The casing 12 opens in an upstream and downstream of a wind flow direction, that is, a front and rear in FIG. 1. Here, as shown in FIGS. 1 and 2, a plate 12a is provided at half of the front opening, which prevents wind from hitting a blade 13d in a reverse rotation direction by not allowing wind to pass through, thereby encouraging rotation of the blade 13d in one direction and increasing power generation efficiency. A mesh 12b is installed on the other half of the front opening to prevent flying objects from hitting the power generation motor 13.

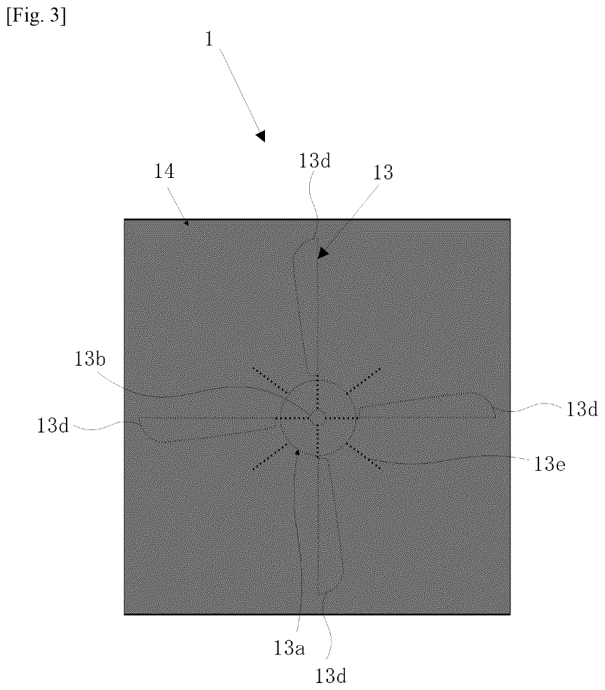

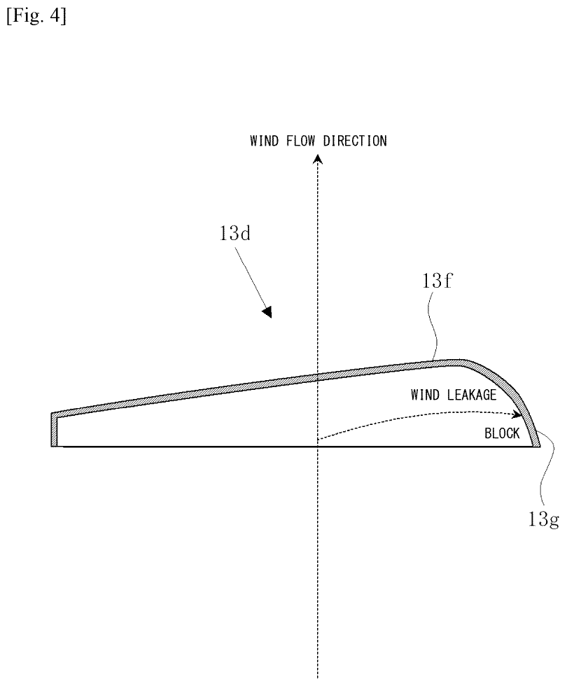

As shown in a horizontal cross-sectional schematic diagram of FIG. 4 (horizontal cross-sectional plan view of FIG. 2), the blade 13d includes a closing portion 13g (wall) that catches the wind in a bag-like shape using a convex shape 13f curved toward a rotation direction of the blade 13d, and blocks the wind from escaping from an end portion of the blade 13d when being perpendicular to the wind flow (in the case of FIG. 3). In any case, the blade should have a structure so as to catch the wind and rotate. Therefore, the convex shape 13f is preferable like a bag split in half that is curved vertically and horizontally. The closing portion 13g may be curved or flat.

The power generation motor 13 includes a main body 13a being a conventional generator fixed to a bottom surface of the casing 12 or to a position where the casing 12 is installed, a rotation shaft 13b rotatably provided in the main body 13a, a coupling rod 13c connected to the rotation shaft 13b and bent downward in a hook shape, and the blade 13d continuously provided to the coupling rod. The short wind-solar hybrid power generation apparatus 11 is realized due to the blade 13d rotating horizontally with respect to an installation surface of the casing 12.

Here, there are four pairs of the coupling rod 13c and the blade 13d that are installed in the same plane at 90° intervals. The main body 13a is fixedly supported by support pillars 13e at the bottom surface of the casing 12 or at the position where the casing 12 is installed. The support pillars 13e may be connected to side surfaces of the casing 12.

The solar power generation panel 14 is not limited in type or method, such as being panel shaped, sheet shaped, detachable, or fixed.

### Embodiment 2

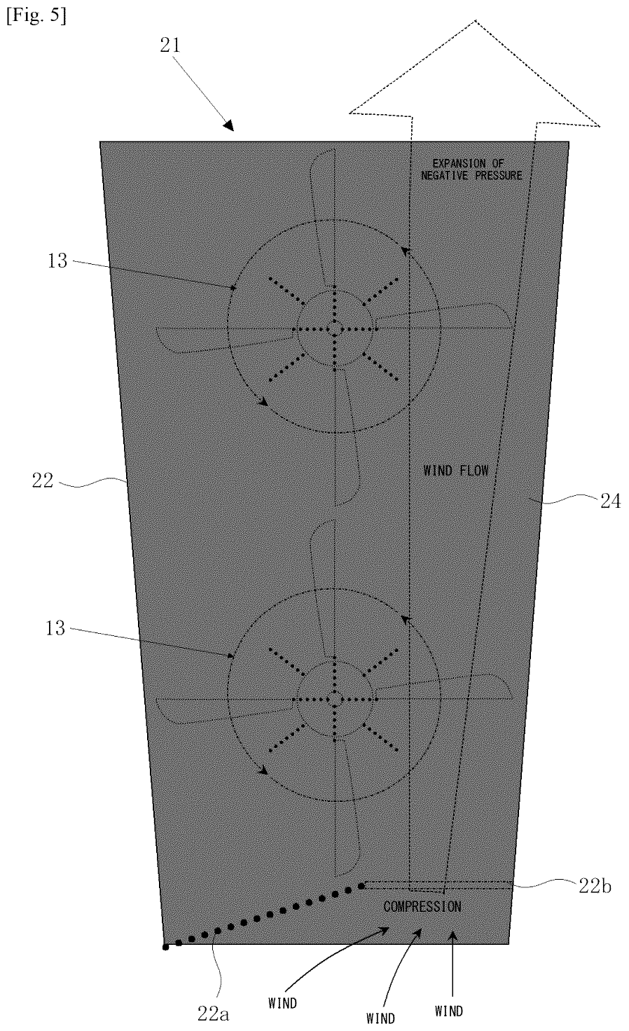

As shown in FIG. 5, Embodiment 2 differs from Embodiment 1 in that two power generation motors 13 are installed in a vertical line in the wind flow direction, as well as a shape of a casing 22 and a shape of a solar power generation panel 14 matching the shape of the casing 22 being different. Note that here, two power generation motors 13 are installed in a vertical line with respect to the wind flow direction, but more may be installed and may be parallel to each other.

A rear opening of the casing 22 in the wind flow direction is larger than a front opening, which creates negative air pressure at the rear, accelerates the wind flow, and efficiently causes the power generation motor to rotate.

A mesh 22b side of a plate 22a is installed so as to incline toward the rear in the wind flow direction, compressing an amount of the wind flow from the mesh 22b near an entrance opening and decompressing the wind flow near a rear exit opening, which allows air to be drawn in and wind speed to be increased.

### Embodiment 3

The wind-solar hybrid power generation apparatuses 11 and 21 according to the present invention can also be installed on buildings. For example, on roofs, rooftops, steel-framed structures, and the like. Generated electricity may be used as is or may be stored.

As described above, the wind-solar hybrid power generation apparatuses 11 and 21 according to the present invention can generate power when there is wind, regardless of whether it is daytime when there is sun or nighttime, which is more efficient than only using one method.

### REFERENCE SIGNS LIST

1 electricity-powered vehicle
2 electric vehicle
11 wind-solar hybrid power generation apparatus
12 casing
12a plate
12b mesh
13 power generation motor
13a main body
13b rotation shaft
13c coupling rod
13d blade
13e support pillar
13f convex shape
13g closing portion
14 solar power generation panel
21 wind-solar hybrid power generation apparatus
22 casing
22a plate
22b mesh
24 solar power generation panel

1. A wind-solar hybrid power generation apparatus comprising:
a square-shaped casing that opens at a front and a rear;
a power generation motor that is installed inside the casing; and
a solar power generation panel that is placed on an upper surface of the casing, wherein
the power generation motor includes:
a main body that is fixed to a bottom surface of the casing or at a position where the casing is installed;
a rotation shaft that is rotatably provided in the main body;
a coupling rod that is connected to the rotation shaft and bent downward in a hook shape; and
a blade that is continuously provided to the coupling rod, and
the blade rotates horizontally with respect to a surface of the position where the casing is installed.

2. The wind-solar hybrid power generation apparatus according to claim 1, comprising four pairs of the coupling rod and the blade.

3. The wind-solar hybrid power generation apparatus according to claim 1, wherein a front surface of the casing in a wind flow direction increases rotation efficiency of the blade by covering a half of the front surface with a plate and not allowing wind to pass through.

4. The wind-solar hybrid power generation apparatus according to claim 3, wherein a mesh is installed on the front surface of the casing in the wind flow direction to prevent flying objects from hitting the power generation motor.

5. The wind-solar hybrid power generation apparatus according to claim 1, wherein the blade comprises a closing portion that has a convex shape curved toward a rotation direction and does not allow wind to escape from an end portion when being perpendicular to wind flow.

6. The wind-solar hybrid power generation apparatus according to claim 1, wherein the power generation motor is installed in plurality in a vertical line in a wind flow direction.

7. The wind-solar hybrid power generation apparatus according to claim 1, wherein a rear opening of the casing in a wind flow direction is larger than a front opening, which creates negative air pressure at the rear, accelerates wind flow, and efficiently causes the power generation motor to rotate.

8. The wind-solar hybrid power generation apparatus according to claim 4, wherein a side at which the mesh of the plate is installed is installed so as to be located and incline toward a rear in the wind flow direction, increasing an amount of wind flow from the mesh.

9. An electricity-powered vehicle comprising the wind-solar hybrid power generation apparatus according to claim 1 on an upper surface of an electric vehicle.

10. The electricity-powered vehicle according to claim 9, wherein a connection between the wind-solar hybrid power generation apparatus and the electric vehicle is of an attachment/detachment type or a fixed type.

11. A building comprising the wind-solar hybrid power generation apparatus according to claim 1.

12. A train comprising the wind-solar hybrid power generation apparatus according to claim 1.

13. A ship comprising the wind-solar hybrid power generation apparatus according to claim 1.
